(19) United States
(12) Patent Application Publication
(10) Pub. No.: US 2026/0365342 A1
(43) Pub. Date: Nov. 19, 2026

(54) COLLISION-RESILIENT ROBOT

(71) Applicants: Yogesh Kumar, Tempe, AZ (US); Karishma Patnaik, Tempe, AZ (US); Wenlong Zhang, Chandler, AZ (US)

(72) Inventors: Yogesh Kumar, Tempe, AZ (US); Karishma Patnaik, Tempe, AZ (US); Wenlong Zhang, Chandler, AZ (US)

(21) Appl. No.: 19/674,654

(22) Filed: May 12, 2026

Related U.S. Application Data
(60) Provisional application No. 63/807,316, filed on May 16, 2025.

(51) Int. Cl. B64U 20/30; B64U 10/14; B64U 30/26; B64U 30/293; B64U 40/10

(52) U.S. Cl. CPC B64U 20/30; B64U 10/14; B64U 30/26; B64U 30/293; B64U 40/10; B64U 2201/10

(57) ABSTRACT

A collision-resilient aircraft includes a body, a plurality of propeller systems, and a propeller linkage system coupling each propeller system to the body. Each propeller linkage system includes a locking mechanism configured to selectively transition the aircraft between a rigid mode and a flexible mode. In the rigid mode, the propeller linkage systems are rigidly coupled to the body for stability during free flight and higher rebound velocities. In the flexible mode, deformation mechanisms allow the propeller systems to pivot and absorb impact forces, returning to an equilibrium state via spring restoration forces. A cam disk, rotated by a powered actuation system, translates locking rods to switch between modes. A controller may autonomously determine an ideal flight mode based on sensor data and a collision model, enabling collision-inclusive trajectory planning in confined environments. The aircraft achieves variable body stiffness, overcoming conventional single-mode limitations to improve agility, resilience, and adaptability.

### CROSS-REFERENCE TO RELATED APPLICATIONS

This application claims priority to and the benefit of U.S. Provisional Patent Application Ser. No. 63/807,316 filed May 16, 2025, entitled “COLLISION-RESISTANT ROBOT,” which is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to robot technology, and more particularly to collision-resilient drone aircraft.

### BACKGROUND

Conventional designs for collision-resilient drone aircraft have suffered significant performance drawbacks due to an inherent trade-off between structural flexibility and rigidity. Unmanned aircraft are typically designed to be either focused on flexibility or collision resistance or, alternatively, focused on rigidity and aerodynamics for speed and maneuverability. For example, conventional collision-resistance drone aircraft are typically designed with compliant propeller guides, compliant arms, passive folding mechanisms, etc. Alternatively, drone aircraft designed to prioritize speed and maneuverability may have rigid propeller guards for higher agility performance. Single-mode designs limit and restrict any individual drone's ability to incorporate collision-inclusive paths and adapt to dynamic environments. Accordingly, improved dual-mode designs are desirable.

### SUMMARY

A collision-resilient aircraft is disclosed. The collision-resilient aircraft may comprise a body; a propeller system coupled to the body by a propeller linkage system; and a locking mechanism configured to selectively transition the propeller system between a rigid mode in which the propeller linkage system is rigidly coupled to the body and a flexible mode in which the propeller linkage system is rotatable with respect to the body.

In various embodiments, the collision-resilient aircraft may comprise a deformation mechanism rotatably coupled to the body. In various embodiments, the deformation mechanism may be configured to pivot in response to the propeller system being in the flexible mode and an impact force being applied to the propeller system such to at least partially absorb the impact force.

In various embodiments, the propeller system may comprise a rigid propeller guard. In various embodiments, the propeller linkage system may comprise a linkage arm. In various embodiments, the linkage arm may couple the rigid propeller guard to the deformation mechanism such that, in response to the propeller system being in the flexible mode and the impact force being applied to the propeller system, the linkage arm is configured to rotate about the deformation mechanism.

In various embodiments, the locking mechanism may comprise a rod configured to extend from a start post extending from the body to an end post extending from the linkage arm. In various embodiments, in response to the propeller system being in the flexible mode, the rod may be retracted from the end post to a first position in which the rod is detached from the linkage arm. In various embodiments, in response to the propeller system being in the rigid mode, the rod may be extended into the end post to a second position in which the linkage arm is fixed along an alignment axis of the rod.

In various embodiments, the collision-resilient aircraft may comprise a middle post extending from the body between the end post and the start post. In various embodiments, in response to the rod being in the first position, the rod may terminate within a channel of the middle post. In various embodiments, in response to the rod being in the second position, the rod may extend from the middle post.

In various embodiments, the propeller system may be one of a plurality of propeller systems. In various embodiments, each propeller system of the plurality of propeller systems may be coupled to the body by one of a plurality of propeller linkage systems. In various embodiments, the locking mechanism may be one of a plurality of locking mechanisms. In various embodiments, each locking mechanism may be configured to selectively transition a corresponding propeller system of the plurality of propeller systems.

In various embodiments, each pair of adjacent propeller linkage systems may be coupled by a spring.

In various embodiments, the collision-resilient aircraft may comprise a controller configured to autonomously operation the locking mechanism based on a collision model.

In various embodiments, the controller may be configured to command a cam mechanism to selectively transition the propeller system between the rigid mode and the flexible mode.

A collision-resilient aircraft is disclosed. The collision-resilient aircraft may comprise a body having a cam disk with a plurality of arcuate slots; a plurality of propeller linkage systems, and a powered actuation system configured to rotate the cam disk in order to translate the rod. In various embodiments, each propeller linkage system may comprise a linkage arm coupling a propeller system to the body, a locking mechanism configured to be selectively coupled to the linkage arm by a rod operatively coupled to the cam disk, and a deformation mechanism pivotable with respect to the body. In various embodiments, an angular position of the linkage arm may be fixed with respect to the body in response to the rod being coupled to the linkage arm and such that the linkage arm is rotatable with respect to the body in response to the rod being uncoupled from the linkage arm. In various embodiments, the deformation mechanism may be configured to rotate the linkage arm in response to the locking mechanism being uncoupled from the linkage arm.

In various embodiments, each rod may be operatively coupled to the cam disk via a protrusion extending from the rod and received within a corresponding arcuate slot of the cam disk, such that a translational displacement of the rod along an alignment axis is determined by a rotation angle of the cam disk.

In various embodiments, the powered actuation system may be configured to rotate the cam disk within rotational limits of approximately 90 degrees from an initial angular offset of the cam disk.

In various embodiments, adjacent deformation mechanisms may be coupled by springs.

In various embodiments, the propeller systems may be configured to be equally spaced about the body in response to the collision-resilient aircraft being in an equilibrium state.

In various embodiments, a first propeller system may be configured to rotate about a corresponding deformation mechanism in response to an impact force applied to the first propeller system and a corresponding rod being uncoupled from a corresponding linkage arm.

In various embodiments, the springs may be configured to apply a restoration force to the first propeller system in response to the impact force being removed.

A method of operating a collision-resilient aircraft is disclosed. The method may comprise determining, by a processor, a current operation mode of the collision-resilient aircraft, the current operation mode being one of a rigid mode or a flexible mode; determining, by the processor, an ideal operation mode of the collision-resilient aircraft, the ideal operation mode being one of the rigid mode or the flexible mode; comparing, by the processor, the current operation mode to the ideal operation mode; maintaining, by the processor, in response to the current operation mode and the ideal operation mode being the same mode, the current operation mode; and selecting, by the processor, in response to the current operation mode and the ideal operation mode being different modes, a new operation mode, the new operation mode being one of the rigid mode or the flexible mode.

In various embodiments, the method may comprise determining, by the processor, environmental conditions along a flightpath based on data receive from a sensor.

In various embodiments, the environmental conditions may include an obstacle in the flightpath. In various embodiments, determining the ideal operation mode may include determining the ideal operation mode based on a collision model.

In various embodiments, selecting the new operation mode may comprise commanding, by the processor, rotation of a cam mechanism of the collision-resilient aircraft to translate a rod between a first position corresponding to the flexible mode and a second position corresponding to the rigid mode. In various embodiments, in response to the rod being in the first position, a propeller system may be in a fixed position with respect to a base of the collision-resilient aircraft. In various embodiments, in response to the rod being in the second position, the propeller system may be rotatable with respect to the base of the collision-resilient aircraft.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a collision-resilient aircraft, in accordance with an exemplary embodiment;

FIG. 2A illustrates a bottom view of a collision-resilient aircraft, in accordance with an exemplary embodiment;

FIG. 2B illustrates an enlarged view of a locking mechanism of the collision-resilient aircraft of FIG. 2A, in accordance with an exemplary embodiment;

FIG. 3A illustrates a top view of a collision-resilient aircraft, in accordance with an exemplary embodiment;

FIG. 3B illustrates an enlarged view of a deformation mechanism of the collision-resilient aircraft of FIG. 3A, in accordance with an exemplary embodiment;

FIG. 4 illustrates an electronics housing of a collision-resilient aircraft, in accordance with an exemplary embodiment;

FIG. 5 illustrates a demonstration of a collision path and response, in accordance with an exemplary embodiment; and

FIG. 6 illustrates a method of controlling a collision-resilient aircraft, in accordance with an exemplary embodiment; and

FIG. 7 illustrates a method of modeling a collision response of collision-resilient aircraft, in accordance with an exemplary embodiment.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to “singular” includes plural embodiments, and any reference to “more than one” component or step may include a singular embodiment or step. Also, any reference to “attached,” “fixed,” “connected,” or the like may include permanent, removable, temporary, partial, full or any other possible attachment option. Additionally, any reference to “without contact” (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

For the sake of brevity, conventional approaches for remote control of autonomous systems such as drone aircraft and/or the like may not be described in detail herein. Furthermore, the connecting lines shown in various figures contained herein are intended to represent exemplary functional relationships and/or physical or communicative couplings between various elements. It should be noted that many alternative or additional functional relationships or physical or communicative connections may be present in a practical system and/or related methods of use, for example a collision-resilient aircraft or the like.

As used herein, “proximate” refers to a position that is near, close to, or in the vicinity of a referenced structure, which may include direct contact, attachment, or a spaced relationship. As used herein, “adjacent” refers to a position that is next to or adjoining a referenced structure, which may include direct contact or a closely spaced relationship without intervening structures therebetween.

Typical collision-resilient quadrotors have avian-like, compliant bodies designed to withstand impacts. These collision-resilient quadrotors have risen to prominence in robotics, aerodynamics, and biology. Leveraging sophisticated collision-tolerant mechanisms, these drone aircraft may exhibit remarkable agility and adaptability, making them invaluable assets in various applications requiring physical interaction with the environment such as navigation in confined environments, haptic-based navigation, and contact-reactive perching. However, these collision-resilient quadrotors typically must trade agility performance for structural resilience.

Conventional collision-resilient quadrotors optimized for structural resilience typically have compliant propeller guards, compliant arms, and/or passive folding mechanisms in order to mitigate damage due to collisions. However, conventional collision-resilient quadrotors optimized for speed, maneuverability, and/or agility typically have rigid propeller guards and/or stiff bodies in order to increase stability and flight performance. Accordingly, conventional collision-resilient quadrotors are typically single-mode drone aircraft: either safeguarded by propeller guards that prevent deformation or are deformable but lacking rigidity, which is crucial for stable flight in open environments.

In contrast to prior approaches, exemplary collision-resilient aircraft of the present application may demonstrate variable body stiffness. The collision-resilient aircraft of the present application may allow for switching between compliant behavior when absorbing impacts and rigid behavior when stability and higher rebound velocities are needed. The collision-resilient aircraft of the present application may have rigid components such as rigid propeller guards, a stiff body, rigid arms, etc. The collision-resilient aircraft of the present application may also have deformation mechanisms for absorbing impact to the rigid components. In various embodiments, the collision-resilient aircraft of the present application may be made more robust and may more broadly incorporate collision-inclusive trajectories than conventional collision-resilient aircraft. The collision-resilient aircraft of the present application may be referred to herein as robots and/or drone aircraft.

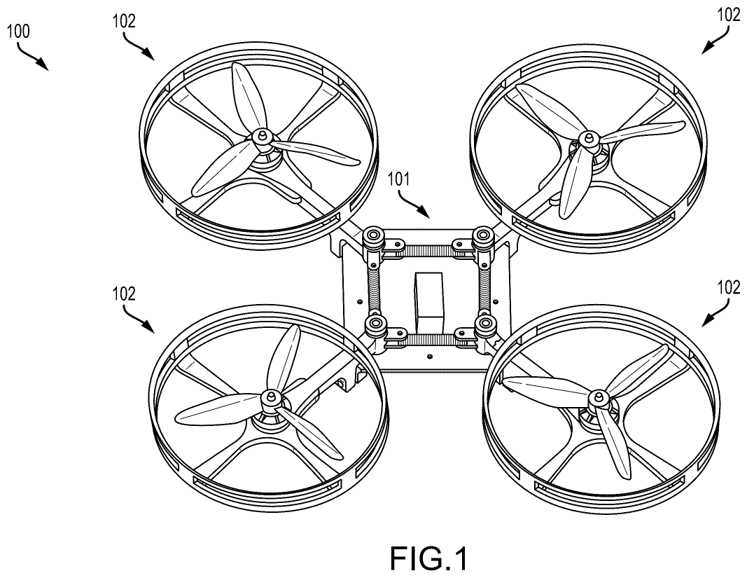

With reference now to FIG. 1, a collision-resilient aircraft 100 is illustrated. In various embodiments, collision-resilient aircraft 100 may be a quadcopter having a base 101 and four propeller systems 102. Collision-resilient aircraft 100 may be a remotely controlled, unmanned aerial vehicles. Collision-resilient aircraft 100 may be autonomously controlled by various controllers. Collision-resilient aircraft 100 may be powered and controlled to use aerodynamic forces for lift. In various embodiments, and as described herein, collision-resilient aircraft 100 of may be a quadcopter (also referred to herein as a quadrotor). However, the disclosure is not limited in this regard. The principles of this disclosure may be applied to collision-resilient hexacopters, collision-resilient octocopters, collision-resilient fixed wing drones with collision-resilient payloads, and the like.

In various embodiments, base 101 may comprise a rigid material such as metal, polymer, ceramic, composite material, wood, or any other suitable material. In various embodiments, the metal may be a ferrous metal or a non-ferrous metal. For example, base 101 may comprise aluminum, stainless steel, titanium, magnesium, brass, bronze, or an aluminum alloy. In various embodiments, the polymer may be a thermoplastic, a thermoset, or an elastomer. For example, base 101 may comprise one or more of polyethylene, polypropylene, nylon, polycarbonate, polyoxymethylene (POM), polyetheretherketone (PEEK), or acrylonitrile butadiene styrene (ABS). Base 101 may be monolithic. Alternatively, base 101 may be comprised of multiple components and/or materials.

In various embodiments, each propeller system 102 may be configured to provide lift to collision-resilient aircraft 100. Each propeller system 102 may be configured to cooperatively operate as the primary means of generating lift, thrust, and directional control of collision-resilient aircraft 100. In various embodiments, propeller systems 102, in cooperative operation, may facilitate the ascent, descent, yaw, pitch, roll, acceleration, deceleration, and/or velocity of collision-resilient aircraft 100.

In various embodiments, collision-resilient aircraft 100 may have dual-stiffness modes. Collision-resilient aircraft 100 may have a flexible mode for smooth contact and low rebound velocities. Collision-resilient aircraft 100 may have a rigid mode for stability during free flight and higher rebound velocities. In various embodiments, the rigid mode may be associated with higher rebound velocities of collision-resilient aircraft 100 than the flexible mode. In various embodiments, the rigid mode may be associated with higher stiffness of collision-resilient aircraft 100 than the flexible mode. In various embodiments, the rigid mode may be associated with a stiffness of collision-resilient aircraft 100 that is at least 5 times a stiffness of the collision-resilient aircraft 100 in the flexible mode. In various embodiments, the rigid mode may be associated with a stiffness of collision-resilient aircraft 100 that is at least 6 times a stiffness of the collision-resilient aircraft 100 in the flexible mode. In various embodiments, the rigid mode may be associated with a stiffness of collision-resilient aircraft 100 that is at least 7 times a stiffness of the collision-resilient aircraft 100 in the flexible mode.

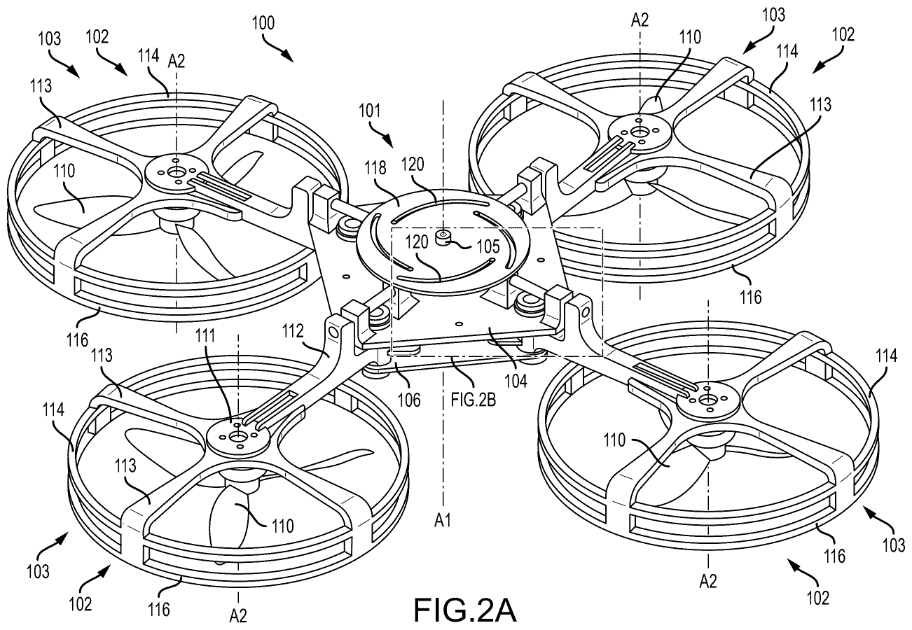

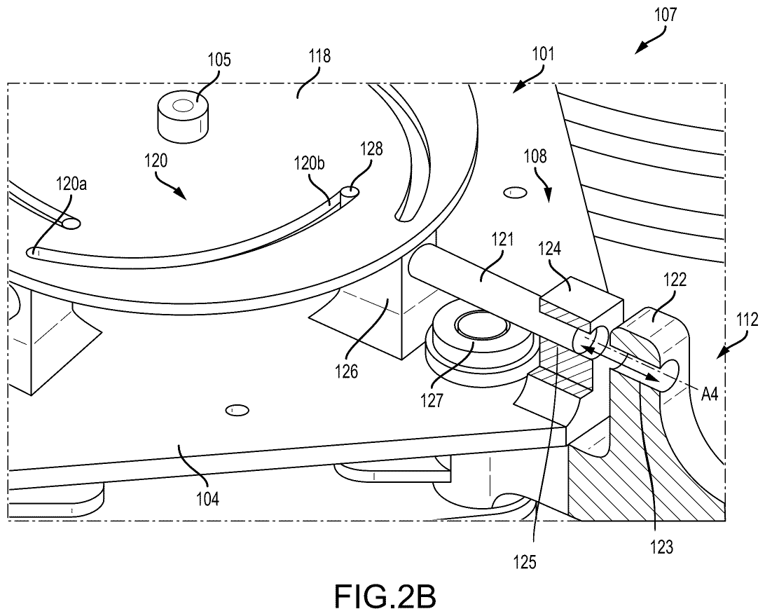

With reference to FIGS. 2A and 2B and in various embodiments, a bottom view of collision-resilient aircraft 100 is illustrated. For illustration purposes, collision-resilient aircraft 100 is illustrated in an upside-down configuration. In various embodiments, body 101 may comprise an upper plate 106 and a lower plate 104. In response to collision-resilient aircraft 100 being in an upright orientation, upper plate 106 is disposed vertically above lower plate 104. A propeller linkage system 107 may be disposed at each corner of body 101. In various embodiments, propeller linkage systems 107 mechanically couple body 101 to each propeller system 102. In various embodiments, propeller linkage systems 107 each comprise a deformation mechanism 109 for absorbing impact to the collision-resilient aircraft 100 in the flexible mode. In various embodiments, propeller linkage systems 107 each comprise a locking mechanism 108 for fixing a position of the propeller systems 102 with respect to the base in the rigid mode.

In various embodiments, propeller systems 102 may each comprise a propeller 110 having aerodynamic blades for creating lift forces for operation of collision-resilient aircraft 100. In various embodiments, propeller systems 102 may each comprise a rigid propeller guard 103. Each rigid propeller guard 103 may comprise an annular component coupled to a linkage arm 112. The annular comprise an upper guard 116 and a lower guard 114. Each rigid propeller guard 103 may comprise a plurality of guard arms 113 extending from a central axle 111 of rigid propeller guard 103 toward lower guard 114. However, in various embodiments, upper guard 116 and lower guard 114 may be a singular annual component with a vertical wall extending a height between upper guard 116 and lower guard 114. Each rigid propeller guard 103 may be coupled to a linkage arm 112, described further below. Linkage arms 112 may extend from and between central axle 111 of rigid propeller guard 103 to base 101.

In various embodiments, rigid propeller guard 103 may comprise a rigid material such as metal, polymer, ceramic, composite material, wood, or any other suitable material or combinations thereof. In various embodiments, the metal may be a ferrous metal or a non-ferrous metal. For example, rigid propeller guard 103 may comprise aluminum, stainless steel, titanium, magnesium, brass, bronze, or an aluminum alloy. In various embodiments, the polymer may be a thermoplastic, a thermoset, or an elastomer. For example, rigid propeller guard 103 may comprise polyethylene, polypropylene, nylon, polycarbonate, polyoxymethylene (POM), polyetheretherketone (PEEK), or acrylonitrile butadiene styrene (ABS).

In various embodiments, rigid propeller guard 103 may be configured to guard propeller 110, and more specifically the blades of propeller 110, from impacting and/or colliding with external objects or people during operation, from crashing in confined environments, from causing damage or injury during operation, etc. In various embodiments, rigid propeller guard 103 may be configured to enhance stability of collision-resilient aircraft 100. Rigid propeller guard 103 may be configured to operate as a shroud and/or a foil to improve propeller efficiency at low speeds and/or allow for “perching” collision-resilient aircraft 100 on various surfaces.

In various embodiments, propellers 110 may be operated by motors disposed within collision-resilient aircraft 100. In various embodiments, propellers 110 may be operated by motors disposed within propeller systems 102, and more specifically disposed proximate central axle 111. In various embodiments, propellers 110 may be operated by motors disposed within base 101. In various embodiments, motors may be brushless DC motors. However, any suitable motors may be utilized, as desired.

In various embodiments, body 101 may comprise an upper plate 106 and a lower plate 104. In various embodiments, each of upper plate 106 and lower plate 104 are generally rectangular plates, or generally square plates. However, the disclosure is not limited in this regard, each of upper plate 106 and a lower plate 104 may be generally circular plates with “corners” being sectors of the circle disposed proximate propeller systems 102. In various embodiments, propeller linkage systems 107 each comprise a locking mechanism 108 coupled to a linkage arm 112, which is in turn coupled to a propeller system 102. In various embodiments, body 101 may comprise propeller linkage systems 107 at each corner.

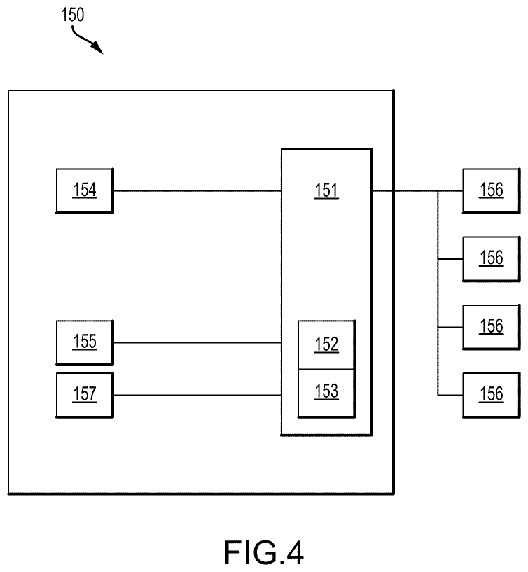

In various embodiments and with additional reference to FIG. 4, body 101 may comprise electronics housing 150 disposed between upper plate 106 and lower plate 104. Electronics housing 150 may be a generally planar member configured to support and secure onboard electronics of collision-resilient aircraft 100. For example, electronics housing 150 may be configured to support a controller 151, a processor 152, a memory 153 one or more electronic speed controllers (ESCs) 154, a power supply 155, a plurality of sensors 156, one or more communication interfaces 157, and any other electronic components of collision-resilient aircraft 100. In various embodiments, the plurality of sensors 156 are disposed externally to electronics housing 150 on body 101 and in communication with electronics housing 150. Electronics housing 150 may be coupled to upper plate 106, lower plate 104, or both. Electronics housing 150 may be fixedly coupled to body 101 by fasteners, adhesives, snap-fit features, or any other suitable attachment means. In various embodiments, electronics housing 150 may be disposed proximate central axis A1 of body 101 such that onboard electronics are centrally located within body 101.

In various embodiments, controller 151 may include processor 152 memory 153. Processor 152 may comprise one or more processors configured to implement various logical operations in response to execution of instructions, for example, instructions stored on a non-transitory, tangible, computer-readable medium. The one or more processors can be a processing chip, a general purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Memory 153 may comprise memory to store data, executable instructions, system program instructions, and/or controller instructions to implement the control logic of processor 152. In various embodiments, controller 151 may be a flight controller. In various embodiments, processor 152 may be an onboard companion computer.

In various embodiments, body 101 may comprise one or more weights configured to adjust a center of gravity of collision-resilient aircraft 100. Weights may be disposed on or within body 101, for example, on upper plate 106, lower plate 104, or electronics housing 150. In various embodiments, weights may be selectively positionable along body 101 to adjust a distribution of mass of collision-resilient aircraft 100 and thereby tune flight stability and performance. Weights may be fixedly or removably coupled to body 101. In various embodiments, weights may be configured to counterbalance the mass of components mounted to electronics housing 150 such that the center of gravity of collision-resilient aircraft 100 remains substantially aligned with central axis A1 of body 101. Maintaining the center of gravity of collision-resilient aircraft 100 substantially along central axis A1 may improve flight stability and control of collision-resilient aircraft 100 in both the flexible mode and the rigid mode.

In various embodiments, propeller linkage systems 107 may each comprise a linkage arm 112. In various embodiments, linkage arm 112 may be a generally linear member coupling the body 101 to one of propeller systems 102. Linkage arms 112 may each be coupled to body 101 at a position between upper plate 106 and lower plate 104 by a pivoting fastener 127 at a fastener axis A3. Linkage arms 112 may be rotatable about a fastener axis A3 in response to collision-resilient aircraft 100 being in a flexible mode. Linkage arms 112 may be fixedly coupled to propeller systems 102. Linkage arms 112 may be fixedly coupled to rigid propeller guard 103 such that linkage arm 112 remains stationary in position and orientation with respect to rigid propeller guard 103.

Pivoting fastener 127 may be a bearing having an inner diameter of between 6 millimeters (mm) and 10 mm or, more specifically, between 7 mm and 9 mm, or more specifically, approximately 8 mm. Pivoting fastener 127 may be a bearing having an outer diameter of between 14 mm and 18 mm or, more specifically, between 15 mm and 17 mm, or more specifically, approximately 16 mm. Pivoting fastener 127 may be a bearing having a bore diameter of between 3 mm and 7 mm or, more specifically, between 4 mm and 6 mm, or more specifically, approximately 5 mm. However, the disclosure is not limited in this regard. Pivoting fastener 127 may be implemented as any suitable fastening element configured to join two or more parts, such as upper plate 106, linkage arm 112, and lower plate 104, in a detachable or non-detachable manner, and may include, without limitation, a bearing of any size, a screw, bolt, stud, rivet, pin, clip, snap-fit feature, or other functionally equivalent securing member. Pivoting fastener 127 may comprise a shank extending along a fastener axis A3 with a head at a first end and a retention feature along at least a portion of the shank, such as threads, knurls, barbs, or an interference-fit profile. Pivoting fastener 127 may fix a linear position of linkage arm 112 with respect to upper plate 106 and lower plate 104 along fastener axis A3 while allowing to pivot about fastener axis A3 with respect to upper plate 106 and lower plate 104.

In various embodiments, linkage arms 112 may each comprise an end post 122 proximate body 101. End posts 122 may be generally vertical components extending vertically downward toward lower plates 104. In various embodiments, end posts 122 may extend past lower plates 104. In various embodiments, each end post 122 may comprise a channel 123 for receiving a rod 121, described in further detail below. Channel 123 may be a cylindrical bore extending at least partially through end post 122. However, the disclosure is not limited in this regard; channels 123 may have a rectangular bore or any other shaped bore. Channels 123 may have an inner diameter corresponding to an outer diameter of rods 121 such that rods 121 may be configured to be in tight-fitting engagement with channels 123. In various embodiments, rods 121 have an outer diameter of between 3 mm and 7 mm. In various embodiments, rods 121 have an outer diameter of between 4 mm and 6 mm. In various embodiments, rods 121 have an outer diameter of about 5 mm.

In various embodiments, linkage arms 112 may comprise a rigid material such as metal, polymer, ceramic, composite material, wood, or any other suitable material or combinations thereof. In various embodiments, the metal may be a ferrous metal or a non-ferrous metal. For example, linkage arms 112 may comprise aluminum, stainless steel, titanium, magnesium, brass, bronze, or an aluminum alloy. In various embodiments, the polymer may be a thermoplastic, a thermoset, or an elastomer. For example, linkage arms 112 may comprise polyethylene, polypropylene, nylon, polycarbonate, polyoxymethylene (POM), polyetheretherketone (PEEK), or acrylonitrile butadiene styrene (ABS).

In various embodiments, lower plate 104 may comprise a middle post 124 disposed at and extending vertically downward from each corner of lower plate 104. Middle posts 124 and end posts 122 may have corresponding dimensions. Middle posts 124 and end posts 122 may be disposed in close proximity to one another with a gap disposed therebetween. Middle posts 124 may each comprise a channel 125 for receiving a rod 121, described in further detail below. Channel 125 may be a cylindrical bore extending fully through middle post 124. However, the disclosure is not limited in this regard; channels 125 may have a rectangular bore or any other shaped bore. Channels 125 may have an inner diameter corresponding to an outer diameter of rods 121 such that rods 121 may be configured to be in tight-fitting engagement with channels 125. Channels 125 and channels 123 may be aligned such that rods 121 may translate from channels 125 into channels 123 in order to secure collision-resilient aircraft 100 in the rigid mode.

In various embodiments, locking mechanisms 108 may each comprise a rod 121. Rods 121 may be cylindrical locking elements. However, the disclosure is not limited in this regard; rods 121 may have a rectangular cross section or any other cross section dimensioned to be received into channels 123 and channels 125. Each rod 121 may comprise a protrusion 128 extending away from lower plate 104. Each protrusion 128 may be configured to extend through an arcuate slot 120 of a cam disk 118, described in further detail below.

In various embodiments, each rod 121 may extend from and between a start post 126 and a middle post 124. Start posts 126 may be disposed near and extending vertically downward from each corner of lower plate 104. Start posts 126 may be disposed closer to a center axis A1 of collision-resilient aircraft 100 than middle posts 124 are disposed. Start posts 126 may be disposed between center axis A1 of collision-resilient aircraft 100 and middle posts 124. Start posts 126 may receive rods 121 in channels, slots, divots, or other openings for receiving rods 121 along an alignment axis A4. Start posts 126, middle posts 124, and end posts 122 may be linearly aligned along alignment axis A4 so as to guide linear translation of rods 121 along alignment axis A4. Alignment axis A4 may intersect fastener axis A3 at a perpendicular angle. Alignment axis A4 may be vertically spaced from pivoting fastener 127 along fastener axis A3. In this manner, and as described further below, rotation of linkage arm 112 about fastener axis A3 may be prevented by fixing linkage arm 112 in a position aligned with alignment axis A4.

In various embodiments, rods 121 may be disposed within channels 125 of middle posts 124 in response to collision-resilient aircraft 100 being in the flexible mode. Rods 121 may terminate within channels 125 of middle posts 124 in response to collision-resilient aircraft 100 being in the flexible mode. Rods 121 may extend from channels 125 of middle posts 124 and into channels 123 of end posts 122 in response to collision-resilient aircraft 100 being in the rigid mode. Rods 121 may terminate within channels 123 of end posts 122 in a first position in response to collision-resilient aircraft 100 being in the flexible mode. In order to switch collision-resilient aircraft 100 from the flexible mode to the rigid mode, rods 121 may be translated to a second position into channels 123 of end posts 122. As channels 123 are configured to receive rods 121 in a tight-fitting engagement, linkage arm 112 is rigidly coupled to body 101 in response to receiving rod 121. Stated differently, in response to receiving rod 121 into channel 123 of end post 122 of linkage arm 112, linkage arm 112 is secured in a stationary position and orientation with respect to rigid propeller guard 103. In order to switch collision-resilient aircraft 100 from the rigid mode to the flexible mode, rods 121 may be translated away from channels 123 of end posts 122 to a position terminating within channels 125 of middle posts 124. Stated differently, in response to removing rod 121 from channel 123 of end post 122 of linkage arm 112, linkage arm 112 is freely rotatable about fastener axis A3.

In various embodiments, body 101 may comprise a cam disk 118 configured to convert rotational motion of cam disk 118 to linear motion of rods 121. Cam disk 118 may have a plurality of arcuate slots 120. Arcuate slots 120 may curve from a first end 120a to a second end 120b. Each second end 120b may be disposed radially closer to central axis A1 of body 101 than each first end 120a. Cam disk 118 may be configured to rotate about central axis A1 of body 101. Rotation of cam disk 118 may cause linear translation of rods 121 between the first position and the second position in order to operate collision-resilient aircraft 100 between the flexible mode and the rigid mode. Cam disk 118 may be operatively and mechanically coupled to each rod 121 via a corresponding protrusion 128. Cam disk 118 may receive each protrusion 128 of rods 121 into a corresponding arcuate slot 120. Accordingly, as cam disk 118 rotates, the radially varied curvature of arcuate slots 120 causes protrusions 128 to translate radially with respect to central axis A1 of body 101 along alignment axis A4. As protrusions 128 translate along alignment axis A4, rods 121 translate along alignment axis A4 between the first position and the second position.

In various embodiments, the relationship between l (translation of aluminum rod) and θ (rotation of cam disc) may be established as follows, where R_{cam} and r are a radius of cam disk 118 and a rotational circle radius, respectively.

l=R_{cam}−r cos(θ) (A)

In various embodiments, a rotational limit of locking mechanism 108 is defined as follows:

θ₀≤θ≤(θ₀+90°) (B)

In various embodiments, cam disk 118 is operated by a powered actuation system 133. The powered actuation system 133 may comprise an electric motor, a linear actuator, a belt drive, a chain drive, a rack and pinion drive, a lead screw, a ball screw, or any other suitable powered drive mechanism. In various embodiments, the powered actuation system 133 may be controlled by a switch, a button, a touchscreen interface, a remote control, a voice command system, or an automated control system. In various embodiments, the powered actuation system 133 may be configured to automatically rotate the cam disk 118 in response to a control signal. In various embodiments, the powered actuation system 133 may include safety features such as obstruction detection sensors, emergency stop mechanisms, speed limiters, or soft-start and soft-stop functionality to ensure safe operation during rotation.

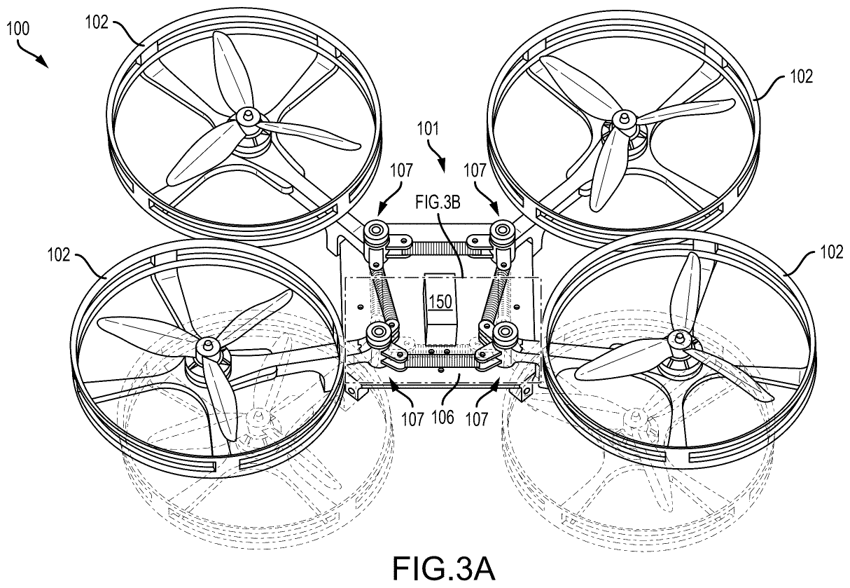

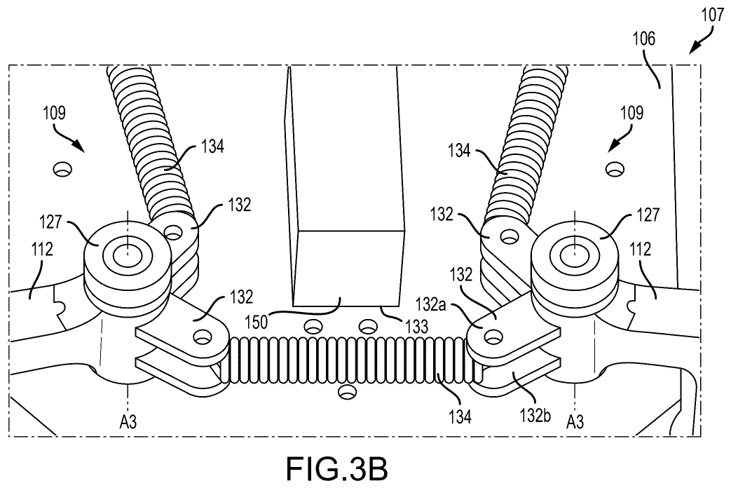

With reference to FIGS. 3A and 3B and in various embodiments, a top view of collision-resilient aircraft 100 is illustrated in an upright configuration. For illustration purposes, upper plate 106 is removed. In various embodiments, deformation mechanisms 109 are disposed at each corner of base 101. In various embodiments, deformation mechanisms 109 are configured to rotate about corresponding fastener axes A3, such that each deformation mechanism 109 may pivot independently about its respective fastener axis A3 in response to an impact force applied to the corresponding propeller system 102. In various embodiments, each deformation mechanisms 109 may be coupled a linkage arm 112. Linkage arm 112 may extend from deformation mechanisms 109 along a corresponding alignment axis A4. In various embodiments and as best illustrated in FIGS. 1 and 2A, deformation mechanisms 109 may have an equilibrium position in which each linkage arm 112 is oriented along a corresponding alignment axis A4 such that the four alignment axes A4 are equally angularly spaced about central axis A1 of base 101, with each adjacent pair of linkage arms 112 disposed at approximately 90 degrees with respect to one another.

In various embodiments, deformation mechanisms 109 each comprise a pair of pivot joints 132. Each pair of pivot joints 132 of one deformation mechanism 109 may be disposed at a 90-degree angle with respect to one another. Each pivot joint 132 may receive an end of a spring 134. Each spring 134 may extend between two pivot joints 132 of adjacent deformation mechanisms 109. Each spring 134 may have an equivalent spring constant such that equal forces are applied to each pivot joint 132 in response to collision-resilient aircraft 100 being in an equilibrium state. As such, each pair of adjacent spring 134 may be disposed at 90-degree angles with respect to each other in response to collision-resilient aircraft 100 being in an equilibrium state. Stated differently, each adjacent spring 134 may be disposed at 90-degree angles with respect to each other in response to collision-resilient aircraft 100 not experiencing an impact force. In various embodiments, each pivot joint 132 may comprise an upper flange 132a spaced apart from a lower flange 132b. Spring 134 may be coupled on each end to a pivot joint 132 between upper flange 132a and lower flange 132b. Spring 134 may be pinned to upper flanges 132a and lower flanges 132b such that spring 134 may pivot about pivot joint 132 as deformation mechanisms 109 rotate about fastener axis A3, for example, in response to impact forces. In various embodiments, springs 134 may have a length of between 0.5 inches and 1.5 inches. In various embodiments, springs 134 may have a length of between 0.7 inches and 1.0 inches. In various embodiments, springs 134 may have a length of between 0.8 inches and 0.9 inches. In various embodiments, springs 134 may have a diameter of between 0.1 inches and 0.5 inches. In various embodiments, springs 134 may have a diameter of between 0.15 inches and 0.35 inches. In various embodiments, springs 134 may have a diameter of between 0.2 inches and 0.3 inches.

In various embodiments, collision-resilient aircraft 100 may have a deformation state in response to collision-resilient aircraft 100 being in a flexible mode and an impact force applied to one or more propeller systems 102. More specifically, collision-resilient aircraft 100 may have a deformation state in response to collision-resilient aircraft 100 being in a flexible mode and an impact force applied to one or more rigid propeller guards 103. In response to an impact force being applied to a rigid propeller guards 103, the corresponding linkage arm 112 may rotate about corresponding fastener axis A3 to a deformation state. In response to linkage arm 112 rotating about fastener axis A3, deformation mechanism 109 may rotate about fastener axis A3. In response to deformation mechanism 109 rotating, pivot joints 132 of deformation mechanism 109 may apply tension forces to attached springs 134. As springs 134 extend, a restoring force may increase in each spring 134. In response to the impact force terminating or being removed from the one or more propeller systems 102, the restoring forces stored in springs 134 may be applied to corresponding deformation mechanisms 109 such that each deformation mechanisms 109 returns to the equilibrium state. In response to each deformation mechanisms 109 returning to the equilibrium state, each linkage arm 112 may return to the equilibrium state. In this manner, in response to being in the flexible mode, collision-resilient aircraft 100 is configured to resiliently react to an impact force applied to one or more propeller systems 102.

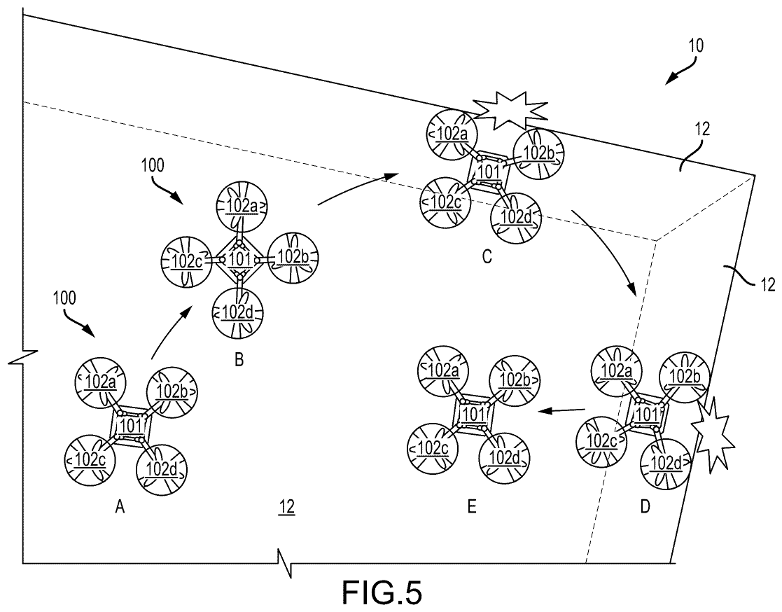

With reference to FIG. 5 and in various embodiments, a collision path and collision response of a collision-resilient aircraft 100 in a flexible mode is illustrated. Collision-resilient aircraft 100 may have a first propeller system 102a, a second propeller system 102b, a third propeller system 102c, and a fourth propeller system 102d. Collision-resilient aircraft 100 may be operating in a confined environment 10. For example, confined environment 10 may be a room, a building, an urban environment, etc. Confined environment 10 may have a plurality of obstacles 12. For example, obstacles 12 may be walls, buildings, vehicles, etc.

As collision-resilient aircraft 100 transits from position A to position B, collision-resilient aircraft 100 avoids obstacles 12 and does not experience an impact force. At position A and B, collision-resilient aircraft 100 is in an equilibrium state in which first propeller system 102a , second propeller system 102b, third propeller system 102c, and fourth propeller system 102d are equally spaced about body 101. As collision-resilient aircraft 100 transits from position A to position B, collision-resilient aircraft 100 may be in a rigid mode.

As collision-resilient aircraft 100 transits from position B to position C, collision-resilient aircraft 100 may detect an impending impact force at an expected position, position C. In various embodiments, collision-resilient aircraft 100 may determine, based on a collision model, that an ideal mode for the impending collision is the flexible mode. In response to the determination, collision-resilient aircraft 100 may command rods 121 to the first position to place collision-resilient aircraft 100 in the flexible mode.

As collision-resilient aircraft 100 transits from position B to position C, collision-resilient aircraft 100 may impact an obstacle 12 and may experience an impact force. At position C, collision-resilient aircraft 100 may be in a deformation state in response to first propeller system 102a and second propeller system 102b impacting obstacle 12. Each of first propeller system 102a and second propeller system 102b may be rotated with respect to body 101 while third propeller system 102c and fourth propeller system 102d may remain in a substantially constant position with respect to body 101.

As collision-resilient aircraft 100 responds to first propeller system 102a and second propeller system 102b impacting obstacle 12, collision-resilient aircraft 100 may transit from position C to position D. Collision-resilient aircraft 100 may resiliently respond to the impact forces and may return to an equilibrium position. As collision-resilient aircraft 100 transits from position C to position D, collision-resilient aircraft 100 may detect an impending impact force at an expected position, position D. In various embodiments, collision-resilient aircraft 100 may determine, based on a collision model, that an ideal mode for the impending collision is the rigid mode. In response to the determination, collision-resilient aircraft 100 may command rods 121 to the second position to place collision-resilient aircraft 100 in the rigid mode.

At position D, collision-resilient aircraft 100 may impact another obstacle 12 and may experience another impact force to second propeller system 102b and third propeller system 102c. At position D, collision-resilient aircraft 100 may be in an equilibrium state in response to second propeller system 102b and third propeller system 102c impacting obstacle 12 and collision-resilient aircraft 100 being in the rigid mode. Each of first propeller system 102a , second propeller system 102b, third propeller system 102c, and fourth propeller system 102d may be at angular positions with respect to body 101 with substantially equal angular spacing.

As collision-resilient aircraft 100 responds to second propeller system 102b and third propeller system 102c impacting obstacle 12, transits from position D to position E, collision-resilient aircraft 100 may avoid obstacles 12 may not experience an impact force. Collision-resilient aircraft 100 may determine a subsequent portion of the flightpath is unobstructed. As collision-resilient aircraft 100 transits from position D to position E, collision-resilient aircraft 100 may determine an ideal flight mode is a rigid mode and may command (and/or maintain) rods 121 to the second position to place collision-resilient aircraft 100 in the rigid mode.

In various embodiments, collision-resilient aircraft 100 may be remotely operated. In various embodiments, collision-resilient aircraft 100 may comprise one or more communication interfaces 157 configured to facilitate remote operation of collision-resilient aircraft 100. Communication interfaces 157 may include, without limitation, a radio frequency (RF) transceiver, a Wi-Fi module, a Bluetooth module, a cellular communication module, or any other suitable wireless communication device. Communication interfaces 157 may be configured to receive remote control signals from a ground control station, a handheld remote controller, or another computing device. The remote control signals may include commands for controlling flight parameters such as thrust, yaw, pitch, roll, altitude, and speed of collision-resilient aircraft 100. In various embodiments, communication interfaces 157 may be configured to transmit telemetry data, sensor data, and video or image data from collision-resilient aircraft 100 to a remote operator or ground control station. In various embodiments, communication interfaces 157 may be configured to transmit a mode state of collision-resilient aircraft 100, indicating whether collision-resilient aircraft 100 is currently in the flexible mode or the rigid mode, to a remote operator or ground control station. In various embodiments, communication interfaces 157 may be configured to receive a mode state command to transition collision-resilient aircraft 100 between the flexible mode or the rigid mode from a remote operator or ground control station. In various embodiments, collision-resilient aircraft 100 may comprise a controller 151 configured to operate powered actuation systems 133 of collision-resilient aircraft 100, for example, to operate cam disk 118 and/or propellers 110.

In various embodiments, collision-resilient aircraft 100 may be autonomously operated. In various embodiments, collision-resilient aircraft 100 may comprise a controller 151 configured to autonomously operate collision-resilient aircraft 100 without input from a remote operator. Controller 151 may execute one or more autonomous flight control algorithms stored in a memory 153 of collision-resilient aircraft 100. The autonomous flight control algorithms may include, without limitation, simultaneous localization and mapping (SLAM) algorithms, model predictive control (MPC) algorithms, reinforcement learning-based control algorithms, proportional-integral-derivative (PID) control algorithms, or any combination thereof. In various embodiments, controller 151 may be configured to autonomously determine whether to switch collision-resilient aircraft 100 between the flexible mode and the rigid mode based on sensor data received from various sensors 156 of collision-resilient aircraft 100. For example, controller 151 may be configured to switch collision-resilient aircraft 100 to the flexible mode in response to detecting an obstacle within a threshold proximity of collision-resilient aircraft 100, and to switch collision-resilient aircraft 100 to the rigid mode in response to detecting that a collision risk has been cleared and that open flight conditions are present. In various embodiments, controller 151 may be configured to execute collision-inclusive trajectory planning such that collision-resilient aircraft 100 may intentionally contact obstacles 12 as part of a planned flight path in order to navigate through confined environments 10. In various embodiments, controller 151 may be powered by a power supply 155 disposed onboard collision-resilient aircraft 100. Power supply 155 may be a rechargeable battery, a fuel cell, or any other suitable onboard power source configured to supply electrical power to controller 151, sensors 156, propeller systems 102, and other powered systems of collision-resilient aircraft 100.

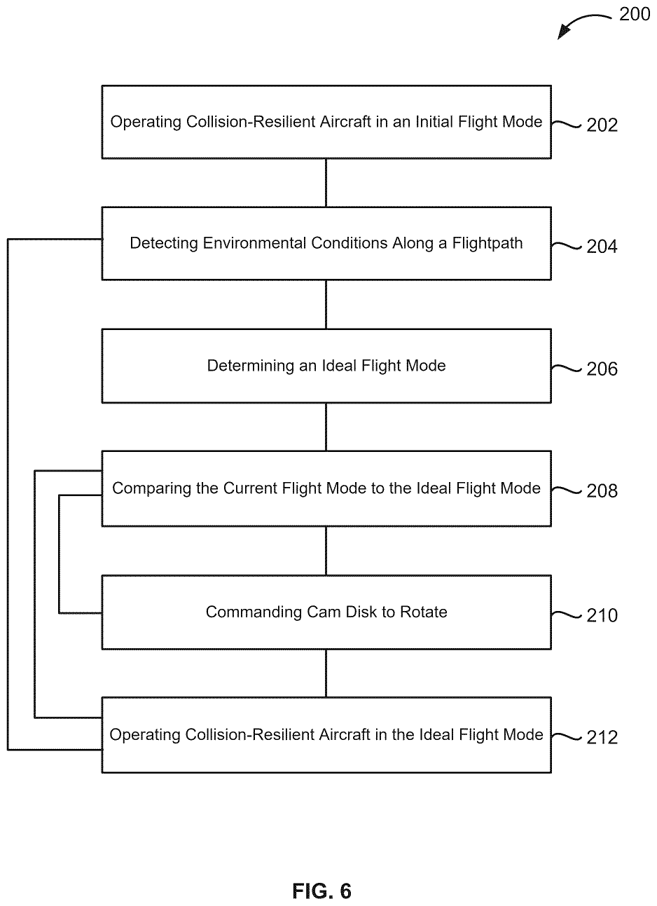

With reference to FIG. 6 and in various embodiments, a method 200 for operating collision-resilient aircraft 100 is disclosed. In various embodiments, method 200 may be executed by controller 151. Method 200 may comprise a step 202 of operating collision-resilient aircraft 100 in an initial flight mode. The initial flight mode may be the rigid mode or the flexible mode. For example, in various embodiments, collision-resilient aircraft 100 may begin operation in the rigid mode, wherein rods 121 are in a second position extending from channels 125 of middle posts 124 into channels 123 of end posts 122, thereby rigidly coupling linkage arms 112 to body 101. In various embodiments, collision-resilient aircraft 100 may instead begin operation in the flexible mode, wherein rods 121 are in a first position retracted within channels 125 of middle posts 124 and linkage arms 112 are freely rotatable about fastener axis A3.

In various embodiments, method 200 may comprise a step 204 of detecting, by sensors 156, environmental conditions along a flightpath of collision-resilient aircraft 100. For example, step 204 may comprise detecting one or more obstacles 12 within a threshold proximity of collision-resilient aircraft 100, detecting an impending impact force at an expected position along the flightpath, or determining that a portion of the flightpath is unobstructed.

In various embodiments, method 200 may comprise a step 206 of determining, by controller 151 and based on a collision model, an ideal flight mode for the detected environmental conditions. For example, controller 151 may determine that the flexible mode is ideal in response to detecting and predictively analyzing an impending collision, may determine that the rigid mode is ideal in response to detecting and predictively analyzing an impending collision, may determine that the rigid mode is ideal in response to detecting that the flightpath is unobstructed, or may determine that the rigid mode is ideal in response to determining that a higher rebound velocity is desired for an impending collision, and/or may determine that the flexible mode is ideal in response to determining that a slower rebound velocity is desired for an impending collision.

In various embodiments, method 200 may comprise a step 208 of determining, by controller 151, whether collision-resilient aircraft 100 is already operating in the ideal flight mode determined in step 206. In response to collision-resilient aircraft 100 already operating in the ideal flight mode, method 200 may return to step 204. Step 204 may comprise comparing the current flight mode to the ideal flight mode. In response to collision-resilient aircraft 100 not operating in the ideal flight mode, method 200 may proceed to step 210.

In various embodiments, method 200 may comprise a step 210 of commanding, by controller 151, cam disk 118 to rotate about central axis A1 of body 101 to translate rods 121 between the first position and the second position to place collision-resilient aircraft 100 in the ideal flight mode determined in step 206.

In various embodiments, step 210 may include computing a target cam rotation angle θ for cam disk 118 based on the ideal mode selected in step 206 using a kinematic model of cam disk 118. In various embodiments, the kinematic model may define a relationship between a translational displacement of rods 121 and a rotation angle of cam disk 118 based on Equation (A), above. In various embodiments, step 210 may comprise computing cam rotation angle θ such that rods 121 are translated to a second position corresponding to the rigid mode in response to the ideal mode being the rigid mode. In various embodiments, step 210 may comprise computing θ such that rods 121 are translated to a first position corresponding to the flexible mode in response to the ideal mode being the flexible mode.

In various embodiments, step 210 may include verifying that the computed cam rotation angle θ falls within rotational limits of cam disk 118 prior to actuating cam disk 118. In various embodiments, the rotational limits of cam disk 118 may be defined by Equation B, above. In various embodiments, in response to the computed cam rotation angle θ falling outside of the rotational limits, step 210 may include generating an alert and/or maintaining a current mode of collision-resilient aircraft 100.

In various embodiments, method 200 may comprise a step 212 of operating collision-resilient aircraft 100 in the ideal flight mode. In response to collision-resilient aircraft 100 operating in the flexible mode, deformation mechanisms 109 may absorb an impact force applied to one or more propeller systems 102, wherein linkage arms 112 rotate about fastener axis A3 and springs 134 store a restoring force, and springs 134 may return each linkage arm 112 and propeller system 102 to an equilibrium state in response to the impact force terminating. In response to collision-resilient aircraft 100 operating in the rigid mode, rigid propeller guards 103 and body 101 may absorb an impact force applied to one or more propeller systems 102, wherein linkage arms 112 remain stationary with respect to body 101 and collision-resilient aircraft 100 remains in an equilibrium state.

In various embodiments, method 200 may return to step 204 to continue monitoring environmental conditions and adjusting the flight mode of collision-resilient aircraft 100 as needed throughout the flightpath.

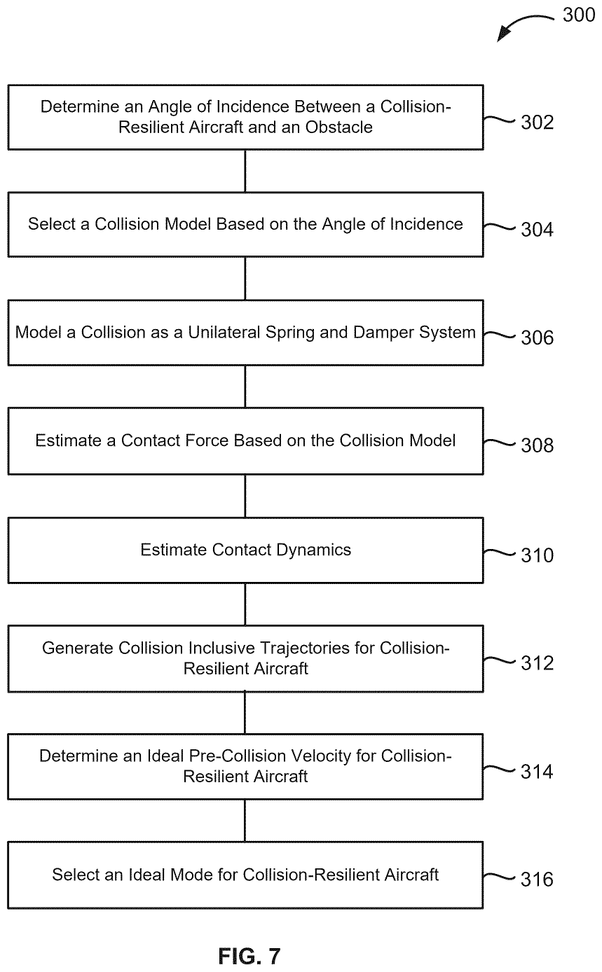

With reference to FIG. 7 and in various embodiments, a method 300 for modeling a collision response of collision-resilient aircraft 100 is disclosed. In various embodiments, method 300 may comprise modeling a collision response of collision-resilient aircraft 100 as a linear spring-damper system.

In various embodiments, method 300 may comprise step 302 to determine an angle of incidence between a collision-resilient aircraft 100 and an obstacle 12. In various embodiments, the angle of incidence is assumed to be zero. In various embodiments, method 300 may comprise step 304 to select a collision model based on the angle of incidence. In various embodiments, in response to being a high angle of incidence, a rigid collision model may be selected for both a rigid mode and a flexible mode of collision-resilient aircraft 100.

In various embodiments, method 300 may comprise step 306 to model a collision. Step 306 may include modeling a collision as a unilateral spring and damper system. In various embodiments, a collision model may include modeling the collision-resilient aircraft 100 as a 3D point mass to develop the translational motion model. In various embodiments, the collision model may include selecting a yaw such that the drone is parallel to the colliding edge. In various embodiments, the collision model may include modeling the 3D point mass with a spring-damper system as a linear complementarity system (LCS) in a state space form.

In various embodiments, method 300 may comprise step 308 to estimate a contact force based on the collision model. In various embodiments, method 300 may comprise step 310 to estimate contact dynamics. In various embodiments, step 308 and step 310 may be performed based on rigid mode inputs and/or flexible mode inputs.

In various embodiments, rigid mode inputs may comprise a rigid spring coefficient (k1), a rigid damping coefficient (f1), a first rigid friction coefficient (μ1), and a second rigid friction coefficient (v1). In various embodiments, the rigid spring coefficient (k1) may be between 5300 N/m and 5700 N/m. In various embodiments, the rigid spring coefficient (k1) may be between 5400 N/m and 5600 N/m. In various embodiments, the rigid spring coefficient (k1) may be 5500 N/m. In various embodiments, the rigid damping coefficient (f1) may be between 13 N-m/s and 17 N-m/s. In various embodiments, the rigid damping coefficient (f1) may be between 14 N-m/s and 16 N-m/s. In various embodiments, the rigid damping coefficient (f1) may be 15 N-m/s. In various embodiments, the first rigid friction coefficient (μ1) may be between 0.1 and 0.5. In various embodiments, the first rigid friction coefficient (μ1) may be between 0.2 and 0.4. In various embodiments, the first rigid friction coefficient (μ1) may be 0.3. In various embodiments, the second rigid friction coefficient (v1) may be between 0.3 and 0.7. In various embodiments, the second rigid friction coefficient (v1) may be between 0.4 and 0.6. In various embodiments, the second rigid friction coefficient (v1) may be 0.5.

In various embodiments, flexible mode inputs may comprise a flexible spring coefficient (k1), a flexible damping coefficient (f1), a first flexible friction coefficient (μ1), and a second flexible friction coefficient (v1). In various embodiments, the flexible spring coefficient (k1) may be between 550 N/m and 950 N/m. In various embodiments, the flexible spring coefficient (k1) may be between 650 N/m and 850 N/m. In various embodiments, the flexible spring coefficient (k1) may be 750 N/m. In various embodiments, the flexible damping coefficient (f1) may be between 6.5 N-m/s and 10.5 N-m/s. In various embodiments, the flexible damping coefficient (f1) may be between 7.5 N-m/s and 9.5 N-m/s. In various embodiments, the flexible damping coefficient (f1) may be 8.5 N-m/s. In various embodiments, the first flexible friction coefficient (μ1) may be between 4.8 and 5.2. In various embodiments, the first flexible friction coefficient (μ1) may be between 4.9 and 5.1. In various embodiments, the first flexible friction coefficient (μ1) may be 5. In various embodiments, the second flexible friction coefficient (v1) may be between 0.5 and 0.9. In various embodiments, the second flexible friction coefficient (v1) may be between 0.6 and 0.8. In various embodiments, the second flexible friction coefficient (v1) may be 0.7.

In various embodiments, method 300 may comprise step 312 to generate collision inclusive trajectories for collision-resilient aircraft 100 based on the collision model and the contact dynamics.

In various embodiments, method 300 may comprise step 314 to determine an ideal pre-collision velocity for collision-resilient aircraft 100 based on the LCS model and the contact dynamics.

In various embodiments, method 300 may comprise step 316 to select an ideal mode for collision-resilient aircraft 100 based on the LCS model and the contact dynamics, wherein the ideal mode is either the rigid mode or the flexible mode.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many other or additional functional relationships or physical connections may be present in a practical system. However, the benefits, advantages, solutions to problems, and any elements that may cause any benefit, advantage, or solution to occur or become more pronounced are not to be construed as important, indispensable, or fundamental features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the specification or claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, a particular feature, structure, or characteristic described in connection with an embodiment is submitted to be within the knowledge of one skilled in the art to affect such feature, structure, or characteristic in connection with other embodiments whether or not explicitly described. After reading the description, it will be apparent to one skilled in the relevant art(s) how to implement the disclosure in other embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A collision-resilient aircraft comprising:
a body;
a propeller system coupled to the body by a propeller linkage system; and
a locking mechanism configured to selectively transition the propeller system between a rigid mode in which the propeller linkage system is rigidly coupled to the body and a flexible mode in which the propeller linkage system is rotatable with respect to the body.

2. The collision-resilient aircraft of claim 1, further comprising a deformation mechanism rotatably coupled to the body, the deformation mechanism configured to pivot in response to the propeller system being in the flexible mode and an impact force being applied to the propeller system such to at least partially absorb the impact force.

3. The collision-resilient aircraft of claim 2, wherein the propeller system comprises a rigid propeller guard, wherein the propeller linkage system comprises a linkage arm, wherein the linkage arm couples the rigid propeller guard to the deformation mechanism such that, in response to the propeller system being in the flexible mode and the impact force being applied to the propeller system, the linkage arm is configured to rotate about the deformation mechanism.

4. The collision-resilient aircraft of claim 3, wherein the locking mechanism comprises a rod configured to extend from a start post extending from the body to an end post extending from the linkage arm, wherein in response to the propeller system being in the flexible mode, the rod is retracted from the end post to a first position in which the rod is detached from the linkage arm, and wherein in response to the propeller system being in the rigid mode, the rod is extended into the end post to a second position in which the linkage arm is fixed along an alignment axis of the rod.

5. The collision-resilient aircraft of claim 4, further comprising a middle post extending from the body between the end post and the start post, wherein in response to the rod being in the first position, the rod terminates within a channel of the middle post, and wherein in response to the rod being in the second position, the rod extends from the middle post.

6. The collision-resilient aircraft of claim 1, wherein the propeller system is one of a plurality of propeller systems, wherein each propeller system of the plurality of propeller systems is coupled to the body by one of a plurality of propeller linkage systems, and wherein the locking mechanism is one of a plurality of locking mechanisms, each locking mechanism configured to selectively transition a corresponding propeller system of the plurality of propeller systems.

7. The collision-resilient aircraft of claim 6, wherein each pair of adjacent propeller linkage systems are coupled by a spring.

8. The collision-resilient aircraft of claim 1, further comprising a controller configured to autonomously operation the locking mechanism based on a collision model.

9. The collision-resilient aircraft of claim 8, wherein the controller is configured to command a cam mechanism to selectively transition the propeller system between the rigid mode and the flexible mode.

10. A collision-resilient aircraft comprising:
a body having a cam disk with a plurality of arcuate slots;
a plurality of propeller linkage systems each comprising:
a linkage arm coupling a propeller system to the body,
a locking mechanism configured to be selectively coupled to the linkage arm by a rod operatively coupled to the cam disk, wherein an angular position of the linkage arm is fixed with respect to the body in response to the rod being coupled to the linkage arm and such that the linkage arm is rotatable with respect to the body in response to the rod being uncoupled from the linkage arm, and
a deformation mechanism pivotable with respect to the body, wherein the deformation mechanism is configured to rotate the linkage arm in response to the locking mechanism being uncoupled from the linkage arm; and
a powered actuation system configured to rotate the cam disk in order to translate the rod.

11. The collision-resilient aircraft of claim 10, wherein each rod is operatively coupled to the cam disk via a protrusion extending from the rod and received within a corresponding arcuate slot of the cam disk, such that a translational displacement of the rod along an alignment axis is determined by a rotation angle of the cam disk.

12. The collision-resilient aircraft of claim 10, wherein the powered actuation system is configured to rotate the cam disk within rotational limits of approximately 90 degrees from an initial angular offset of the cam disk.

13. The collision-resilient aircraft of claim 10, wherein adjacent deformation mechanisms are coupled by springs.

14. The collision-resilient aircraft of claim 13, wherein the propeller systems are configured to be equally spaced about the body in response to the collision-resilient aircraft being in an equilibrium state.

15. The collision-resilient aircraft of claim 14, wherein a first propeller system is configured to rotate about a corresponding deformation mechanism in response to an impact force applied to the first propeller system and a corresponding rod being uncoupled from a corresponding linkage arm.

16. The collision-resilient aircraft of claim 15, wherein the springs are configured to apply a restoration force to the first propeller system in response to the impact force being removed.

17. A method of operating a collision-resilient aircraft, the method comprising:
determining, by a processor, a current operation mode of the collision-resilient aircraft, the current operation mode being one of a rigid mode or a flexible mode;
determining, by the processor, an ideal operation mode of the collision-resilient aircraft, the ideal operation mode being one of the rigid mode or the flexible mode;
comparing, by the processor, the current operation mode to the ideal operation mode;
maintaining, by the processor, in response to the current operation mode and the ideal operation mode being the same mode, the current operation mode; and
selecting, by the processor, in response to the current operation mode and the ideal operation mode being different modes, a new operation mode, the new operation mode being one of the rigid mode or the flexible mode.

18. The method of claim 17, further comprising determining, by the processor, environmental conditions along a flightpath based on data receive from a sensor.

19. The method of claim 18, wherein the environmental conditions include an obstacle in the flightpath, and wherein determining the ideal operation mode includes determining the ideal operation mode based on a collision model.

20. The method of claim 17, wherein selecting the new operation mode comprises commanding, by the processor, rotation of a cam mechanism of the collision-resilient aircraft to translate a rod between a first position corresponding to the flexible mode and a second position corresponding to the rigid mode,
wherein, in response to the rod being in the first position, a propeller system is in a fixed position with respect to a base of the collision-resilient aircraft, and
wherein, in response to the rod being in the second position, the propeller system is rotatable with respect to the base of the collision-resilient aircraft.
